(19) United States
(12) Patent Application Publication
(10) Pub. No.: US 2024/0348446 A1
(43) Pub. Date: Oct. 17, 2024

(54) Golf Ledger and Token

(71) Applicant: Ke Ma, Surrey (CA)

(72) Inventor: Ke Ma, Surrey (CA)

(21) Appl. No.: 18/636,299

(22) Filed: Apr. 16, 2024

Related U.S. Application Data
(60) Provisional application No. 63/459,889, filed on Apr. 17, 2023.

(51) Int. Cl. H04L 9/32

(52) U.S. Cl. CPC H04L 9/3213

(57) ABSTRACT

This invention pertains to the fields of distributed ledger, cryptocurrency, and decentralized physical infrastructure network. It solves the problems of the blockchain trilemma and cryptocurrency's lack of a real-world value that is recognizable to the mainstream population. Those two problems have prevented any cryptocurrency from gaining mass adoption. The Golf Ledger is distributed across a network of computers that are installed at up to 40,000 golf courses to leverage the existing decentralization of the world's golf courses and their ownership entry barrier and therefore does not need to sacrifice scalability for decentralization and security. The Golf Token as the native cryptocurrency of the Golf Ledger network is rewarded to golf courses for their contributing more and more computing resources to make the network more scalable. Their customers can use the Golf Token to pay golfing fees and get a discount, which is an obvious real-world value.

### BACKGROUND

On Jan. 3, 2009, the Bitcoin network went live. In the aftermath of the 2008 Global Financial Crisis, many people lost faith in the financial system under central banks' fiat currency regime. Decentralized cryptocurrencies such as bitcoin seemed to hold the promise of a new financial system to save humanity from the recurrent financial crisis and perpetual inflation that are inherent in centralized fiat systems. But fifteen years have passed and no decentralized cryptocurrency has been successful to gain mass adoption, mainly because of the following two problems.

Problem 1: Most decentralized cryptocurrencies are based on a form of distributed ledger called “blockchain”, which is distributed across a decentralized network of nodes. They are trapped in a “blockchain trilemma”, as first described in 2014 by Ethereum co-founder Vitalik Buterin, namely, a blockchain cannot scale without sacrificing its decentralization or security. For example, bitcoin (BTC) transactions have been notoriously slow due to low throughput of the Bitcoin network. But the Bitcoin community, in order to ensure decentralization, refuses to increase the Bitcoin blockchain's block size to speed up transactions. This is because bigger block size will require more computing resources (e.g., CPU, storage, bandwidth) and hence higher cost to run “full nodes” where the Bitcoin blockchain is distributed. As the Bitcoin network relies on volunteers to run full nodes, higher cost will hurt its decentralization by prohibiting the vast majority of the population from affording to run full nodes. Various attempts have been made to circumvent the blockchain trilemma. For example, the Bitcoin community has been promoting the Lightning Network as a second-layer scaling solution to increase transaction speed. But the Lightning Network is much less decentralized and secure than the Bitcoin network itself. Faster transactions through the Lightning Network don't actually enjoy the same benefit of decentralization and security as slower transactions directly on the Bitcoin blockchain. Other blockchains such as Algorand, Avalanche, Near, Solana, and the Internet Computer have used different innovations to scale and have achieved impressive transaction speeds; nonetheless, their decentralization or security has not been adequate to gain them widespread trust. The blockchain trilemma also applies to other forms of distributed ledgers such as directed acyclic graph, on which a small number of cryptocurrencies are built, for example, the Hedera Hashgraph. Due to this trilemma, until now, no decentralized cryptocurrency has achieved the required level of decentralization, security, and scalability all at once for mass adoption.

Problem 2: Decentralized cryptocurrencies do not have valuable physical properties like precious metals such as gold, nor are they backed by governments as media of exchange like fiat currencies such as the U.S. dollar. They lack a real-world value that is recognizable to the mainstream population, as Warren Buffett told CNBC on Feb. 24, 2020: “Cryptocurrencies basically have no value and they don't produce anything”. Despite the fact that bitcoin has had some success in establishing itself as “digital gold”, the mainstream population is still skeptical about the value of decentralized cryptocurrencies.

### SUMMARY OF THE INVENTION

The Golf Ledger and Token is the invention to solve the above two problems, namely, decentralized cryptocurrencies' inability to achieve the required level of decentralization, security, and scalability all at once for mass adoption and their lack of a real-world value that is recognizable to the mainstream population.

### DETAILED DESCRIPTION OF THE INVENTION

The Golf Ledger is a distributed ledger that is distributed across a network of computers or data centers that are installed at up to 40,000 golf courses that exist around the globe. Only golf courses are allowed to join this Golf Ledger network to run full nodes which process transactions while keeping synchronized copies of the ledger. Each golf course can run only one full node and must house it at its own facility on or near the course. As golf courses across the world are already superbly decentralized in terms of geography and ownership, the Golf Ledger leverages this existing decentralization and therefore is already superbly decentralized without having to sacrifice scalability for decentralization like Bitcoin. To safeguard decentralization, large golf management companies will be restricted in the number of full nodes they can control. In comparison, the Bitcoin network currently has a total of about 15,000 reachable full nodes, of which a centralized entity can openly or secretly own huge swaths.

The Golf Ledger is also superbly secure because it is practically immune to a 51% attack as the prohibitive cost of owing a golf course makes it practically impossible for a malicious party to have control of more than 50% of the golf courses on the network. In comparison, the Bitcoin blockchain has to use a mechanism called “proof of work” to prevent a 51% attack. The “work” is basically to consume energy by machines called “miners”, which the Bitcoin network uses for the job of adding blocks to the blockchain. The higher is the price of bitcoin, the more miners would join the Bitcoin network to spend energy to compete for the job of adding blocks in order to receive bitcoin as rewards in a process that is called “mining”. With more miners consuming more energy, it becomes more expensive for a malicious party to gain more than 50% of the mining power to launch a 51% attack on the Bitcoin blockchain. In the case of the Ethereum blockchain, it switched from “proof of work” to “proof of stake” in 2022 and no longer uses mining. The “stake” refers to the amount of ether (the native cryptocurrency of the Ethereum network) that full nodes have to lock up as collateral in order to be eligible to add blocks and receive ether as rewards. The higher the price of ether, the more expensive for a malicious party to obtain more than 50% of the total stake to launch a 51% attack. For both bitcoin and ether, the security of their ledgers (i.e., the Bitcoin and Ethereum blockchains) depends on their market value. If their prices decrease, their ledgers become more vulnerable to a 51% attack. In events of rapidly collapsing prices, a death spiral (where lower prices make the network less secure and less security make prices even lower) can occur to threaten the viability of their networks.

The Golf Token is the native cryptocurrency of the Golf Ledger network that users need for conducting transactions and paying fees. It is the economic incentive that holds the network together because golf courses can receive Golf Token as rewards by joining the network to run full nodes. The amount of Golf Token a golf course can receive depends on the amount of computing resources it provides to the network to support transaction capacity. This is vastly different from the Bitcoin network where bitcoin rewards are based on how much computing resources are used to burn energy to mine bitcoin instead of being used to support transaction capacity. This is also vastly different from Ethereum where rewards are mostly based on how much money you can put up as collateral and there isn't much incentive for adding computing resources to increase transaction capacity. With the Golf Token, golf courses have to provide more and more computing resources to support transaction capacity in order to compete for rewards. Such an incentive mechanism makes the Golf Ledger network scalable to handle mass adoption while at the same time its superb decentralization and security remain intact.

Besides being the native cryptocurrency of the Golf Ledger network, the Golf Token can also be used as a payment method for golfing fees at the golf courses on the Golf Ledger network and customers can get a discount when they use the Golf Token to pay. For example, if the price of one round of golf is $100 and the market price of a Golf Token is $45 dollars, a customer may only need to pay 2 Golf Token, which is equal to $90. Such usefulness gives the Golf Token a real-world value that is instantly recognizable to the mainstream population.

By leveraging the existing decentralization and ownership entry barrier of the world's golf courses, the Golf Ledger is superbly decentralized and secure. By using an incentive model based on computing resources for transaction capacity, the Golf Ledger network can effectively scale to be enormously powerful and efficient to handle transactions without hurting its superb decentralization and security. As a result, the Golf Token is able to achieve the required level of decentralization, security, and scalability all at once for mass adoption. By being accepted as a payment method with a discount benefit at golf courses worldwide on the Golf Ledger network, the Golf Token gains an obvious real-world value that is recognizable to the mainstream population. With its superb decentralization, superb security, enormous transaction capacity and an obvious real-world value, the Golf Token is ready to succeed in gaining mass adoption.

1. A network of computers or data centers that are installed at or near golf courses to achieve decentralization.

2. A distributed ledger that is distributed across a network of computers or data centers that are installed at or near golf courses to achieve decentralization and security.

3. A digital token or cryptocurrency that is rewarded to golf courses for their installing computers or data centers at or near their locations to form a decentralized network.
